(19) United States
(12) Patent Application Publication
(10) Pub. No.: US 2011/0029284 A1
(43) Pub. Date: Feb. 3, 2011

(54) SIGNAL ACQUISITION DEVICE

(76) Inventors: Eberhard BOEHL, Reutlingen (DE); Matthias Knauss, Schorndorf (DE); Stephen Schmitt, Nuertingen (DE); Juergen Hanisch, Bempflingen (DE); Rolf Kurrer, Stuttgart (DE); Bernard Pawlok, Stuttgart (DE)

Correspondence Address: KENYON & KENYON LLP, ONE BROADWAY, NEW YORK, NY, 10004, US

(21) Appl. No.: 12/839,508

(22) Filed: Jul. 20, 2010

(30) Foreign Application Priority Data
Jul. 31, 2009 (EP) 0 9166984.6

(51) Int. Cl. G06F 15/00; G06F 17/40

(52) U.S. Cl. 702/187

(57) ABSTRACT

A signal acquisition device which receives an input signal, a physical data and a timing data to generate an output data. The signal acquisition device keeps monitoring the input signal for a valid edge. When a valid edge is detected, the signal acquisition device reads the physical data from a physical data processing module and a timing data from a timing module to generate the output data which comprises the new state of the input signal, the physical data and the timing data. The output data is written to a storage arrangement and also sent out to CPU or any other devices.

### RELATED APPLICATION INFORMATION

The present application claims priority to and the benefit of European Patent Application No. 09 166 984, which was filed on Jul. 31, 2009, the disclosure of which is incorporated herein by reference.

### FIELD OF THE INVENTION

The present invention relates to a signal acquisition device which receives different signals as inputs and generates an output data comprising all the inputs at a given instance which is triggered by change of state of one of the input signals.

### BACKGROUND INFORMATION

U.S. Pat. No. 7,257,396 discusses a system and a method for collecting, storing and time-stamping telematics data. A programmable logic control unit is described that is connected to one or more sensors mounted on a vehicle to capture, time-stamp and store telematics data. And, upon the happening of a triggering event, time-stamped telematics data is transferred from the control unit to an external device.

### SUMMARY OF THE INVENTION

The device according to the descriptions herein has the below mentioned advantages: Supplying the output data which comprises the physical data and the timing data along with the new state of the input signal provides an opportunity to analyse the physical data and the timing data to determine the behaviour of the physical value at a specific instance of time and the input signal value (or the new state of the input signal) when the input signal changed state either from 0 to 1 or 1 to 0.

Also as the output data contains the new state of the input signal, the physical data and the timing data together, the load on the other devices to read the physical data and the timing data separately whenever the input signal changes state, is reduced. In addition the context between the physical data and timing data and the input signal value is provided by the composition of all three. The signal acquisition device provides the combined out-put data to other devices.

Further improvements and/or advantages are realised by the features further described herein.

The signal acquisition device provides output data in serial format as well as parallel format which needs simple hardware interface with other devices.

### BRIEF DESCRIPTIONS OF THE DRAWINGS

FIG. 1 shows the signal acquisition device according to a first embodiment.

FIG. 2 shows the signal acquisition device according to a second embodiment.

### DETAILED DESCRIPTION

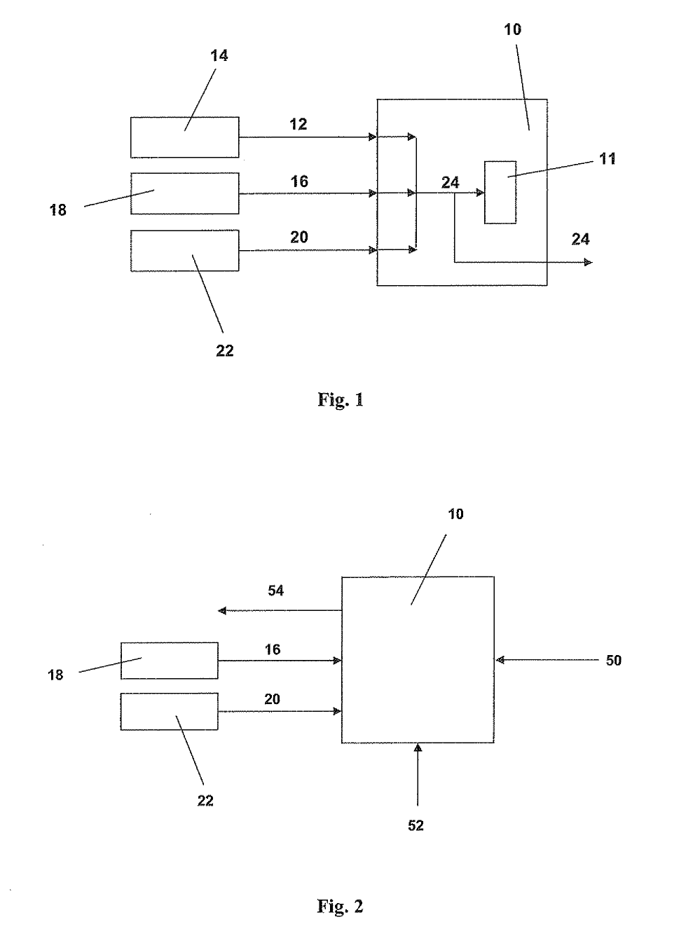

Shown in FIG. 1 are a signal acquisition device 10 and the devices supplying inputs to the signal acquisition device 10. The signal acquisition device 10 receives an input signal 12, a physical data 16 and a timing data 20 to generate an output data 24. The output data 24 is stored in the storage arrangement 11 or sent out to other devices.

The input signal 12 is provided by a sensor module 14. The input signal 12 is a binary signal having two states; a 0 or a 1. The input signal 12 is used as trigger to acquire the physical data 16, the timing data 20 and the state of the input signal 12 by the signal acquisition device 10. A rising edge and/or a falling edge of the input signal 12 can be used to acquire the data.

The physical data 16 is provided by the physical data processing module 18. The physical data 16 may be any physical value like angle, length unit, temperature, voltage, pressure, and mass, current etc. The physical data processing module 18 can be realized as a free running counter, which counts pulses generated by a DPLL (not shown) by processing arbitrary sensor data events. There is also the possibility to process the output data (24) for this reason in the DPLL and count the output pulses of the DPLL in the physical data processing unit 18.

The timing data 20 is provided by the timing module 22. The timing module 22 receives the system clock which is not shown in the figure. The timing module 22 is a free running counter which counts the system clock pulses from 0 to the maximum value limited by the number of counting elements. Once the counter reaches the maximum value, it starts counting again from 0.

The signal acquisition device 10 can be configured to acquire the data with the rising edge and/or the falling edge of the input signal 12. The edge with which the data needs to be acquired is referred as a valid edge. The signal acquisition device 10 keeps monitoring the input signal 12 for a valid edge to acquire the data. Once it detects a valid edge, the signal acquisition device 10 reads the physical data 16 and the timing data 20 and generates the output data 24 which comprises the new state of the input signal 12, the physical data 16 and the timing data 20. The output data is also written into the storage arrangement. Thus, the input signal 12 and the physical data 16 are stored along with the timing data 20 which acts as an extended time stamping; this means that not only the actual timing data but also the actual physical data at the valid edge of the input signal are recorded together with the input signal state. The signal acquisition device 10 also sends out the output data 24. Any device which needs to analyse the physical data with respect to the input signal 12 and the timing data 20 can receive the output signal 24 and carry on the analysis.

The output data 24 can be in the form of a serial data or a parallel data. The output data 24 can go to CPU or any other devices.

The signal acquisition device 10 keeps generating the output data 24 for every valid edge of the input signal 12. The output data is stored and overwritten for every new valid edge, if the time between valid edges is sufficient for further processing by following modules. Also the output data can be stored in the storage arrangement depending upon the capacity of the storage arrangement.

The type and the way of generating the output data 24 by arranging the input signal 12, the physical data 16 and the timing data 20 as well as the state of the input signal 12 that should be reacted to is configurable. There may be more than one input signal; the physical data and the timing data may have to be acquired with respect to a particular input signal. As the signal acquisition device 10 supplies the extended time stamped data, the load on the other devices to read the input signal, the physical data and the timing data, is reduced and all data are brought in a context together.

A further advantage of the aforementioned circuit is that not only the input signal 12 is time stamped using the timing data 20 but also the physical data 16 at the time when the input signal 12 was detected as valid, is time stamped using the timing data 20. The device can be used, for example, for signal acquisition to control an engine.

Knowledge about the position of the pistons in the combustion cylinder along with the current system time plays an important role in the engine control. The engine position is determined through the position of the crankshaft. For this, there is a crankshaft sensor that generates a crankshaft position signal based on the teeth of the crankshaft tone wheel which move past it. Normally the crankshaft position signal is a low resolution signal, for example, if there are 60 teeth on the crankshaft tone wheel, each pulse represents 6 degrees. The angle information is computed by a DPLL based on the previous crank shaft position signal measurements. The crankshaft position signal is given as input signal 12 and the angle information is given as the physical data value (e.g. angle clock) 16 to the signal acquisition device 10. The system clock is given as input to the timing module 22. The data acquisition device 10 keeps monitoring the valid edge on the input signal 12. Once a valid edge is detected, data acquisition device 10 reads the system time from the timing module, the angle information from the angle module and generates the output data. With the output data 24, it can be analysed how the angle information is behaving with respect to the system time.

Shown in FIG. 2 is another embodiment of the present invention. Here the signal acquisition device 10 receives a time stamped and physical value stamped signal 50. The physical value stamped signal refers to a signal which has a physical value assigned to it in the same sense as time stamping i.e. a signal value and a physical value assigned to the signal value. The time stamped and physical stamped value signal 50 comprises an event signal, a physical event data and a time event data for generation of the event. The signal acquisition device 10 keeps comparing the physical event data with physical data 16 from the physical data processing module 18 and the time event data with the timing data 20 from the timing module 22. When one or both the comparisons match, the signal generation unit delivers the event signal from the physical and time stamped signal 50 as the valid output signal 54. Here the data generation device 10 can receive the time stamped signal directly from the CPU over the bus interface 52.

What is claimed is:

1. A signal acquisition device, comprising:
a storage arrangement;
a receiving arrangement to receive an input signal from a sensor module, physical data from a physical data processing module, timing data from a timing module; and
a generating arrangement to generate output data, which includes a new state of the input signal, which is one of high and low, the physical data and the timing data.

2. The signal acquisition device of claim 1, wherein the new state of the input signal, the physical data and the timing data are stored in the storage arrangement when a valid edge is detected on the input signal.

3. The signal acquisition device of claim 2, wherein the valid edge of the input signal is configurable as at least one of (i) from 0 level to 1 level, and (ii) from 1 level to 0 level.

4. The signal, acquisition device of claim 1, wherein the output data is serial data.

5. The signal acquisition device of claim 1, wherein the output data is parallel data.

6. The signal acquisition device of claim I, wherein the input data is crankshaft data of a combustion engine.

7. The signal acquisition device of claim 1, wherein the signal acquisition unit receives a time stamped and physical value stamped signal having an event signal, a physical event data and time event data.

8. The signal acquisition device of claim 1, wherein the signal acquisition device compares the physical event data with physical data from the physical data processing module, and wherein the signal acquisition device compares the time event data with the timing data from the timer module, and when one of the comparisons or both of the comparisons match, the signal acquisition unit provides the event signal at the output.

9. The signal acquisition device of claim 7, wherein the signal acquisition device compares the physical event data with the physical data from the physical data processing module, and wherein the signal acquisition device compares the time event data with the timing data from the timer module, and when one of the comparisons or both of the comparisons match, the signal acquisition unit provides the event signal at the output.

10. A method to generate a data signal, the method comprising:
receiving an input signal, physical data and timing data;
generating the output data, which includes a new state of the input signal, the physical data and the timing data, when a valid edge is detected on the input signal;
storing the output data in a storage arrangement; and
sending the output data to other devices.
